(19) United States
(12) Patent Application Publication
(10) Pub. No.: US 2003/0081194 A1
(43) Pub. Date: May 1, 2003

(54) Method for scanning and autocropping the valid scope of a frame or consecutive frames of negative film

(76) Inventor: Shih-Wen Chen, Taichung Hsien (TW)

Correspondence Address: SUPREME PATENT SERVICES, POST OFFICE BOX 2339, SARATOGA, CA, 95070, US

(21) Appl. No.: 10/032,884

(22) Filed: Oct. 29, 2001

(51) Int. Cl. G03B 27/32

(52) U.S. Cl. 355/77; 355/26; 355/23; 358/296; 358/487; 348/96; 348/97

(57) ABSTRACT

A method for scanning and autocropping the valid scope of a frame or consecutive frames of negative film comprises several steps, including step (A) through step (G). Step (A) is to build a database of negative film. Step (B) is to preview a negative film frame for obtaining a plurality of vertex coordinates. Step (C) is to calculate coordinates of the center of the frame according to the vertex coordinates obtained. Step (D) is to input the brand name of the negative film through an input interface of the scanner driver. Step (E) is to search the database for a valid frame scope of the negative film according to the brand name thereof. Step (F) is to calculate the plurality of vertex coordinates in the valid frame scope according to the coordinates of center and the valid frame scope of the negative film. And, step (G) is to display a cropped scope, that is the valid frame scope of the negative film, according to the plurality of the vertex coordinates in the valid frame scope of the negative film.

### FIELD OF THE INVENTION

This invention relates to a professional scanner implemented for scanning positive/negative films, particularly a desktop scanner combined with a photo mask for scanning and converting a negative film frame into a positive image for photo digitization.

### BACKGROUND OF THE INVENTION

When a conventional scanner is employed to scan a negative film, a process for enlarging a target picture is usually required to facilitate a correct autocrop of scan scope.

However, the existing scanner can autocrop only an entire frame or consecutive frames of a negative film, namely, it usually autocrops a frame including valid and invalid sections, it fails to autocrop a pure valid section of the negative film separately. As it doesn't really help for autocropping an image desired, a user has to do it by manual manipulation.

As to solve this problem, a fixing clamp designed specifically may be taken though, it is inapplicable to all kinds or brands of negative film.

In view of abovesaid imperfection, a method for scanning and autocropping a valid scope of negative film is proposed by this invention to be described below for improvement.

### SUMMARY OF THE INVENTION

The primary object of this invention is to provide a method for scanning and autocropping the valid scope of a frame or consecutive frames of negative film for saving troubles of preview enlargement in a conventional process.

In order to realize abovesaid object, the method of this invention comprises several steps as described below.

Step (A) is to build a database of negative film for application of a scanner driver, in which brand names and frame measurements of various negative films are recorded. Step (B) is to preview the frame scope of a negative film for obtaining a plurality of vertex coordinates. Step (C) is to calculate coordinates of the center of the frame according to the vertex coordinates obtained. Step (D) is to input the brand name of the negative film through an input interface of the scanner driver. Step (E) is to search the database for a valid frame scope of the negative film according to the brand name thereof. Step (F) is to calculate the plurality of vertex coordinates in the valid frame scope according to the coordinates of center and the valid frame scope of the negative film. And, step (G) is to display a cropped scope, that is the valid frame scope of the negative film, according to the plurality of the vertex coordinates in the valid frame scope of the negative film.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1A shows a flowchart in performance of this invention for a negative film;

FIG. 1B shows a flowchart in performance of this invention for consecutive negative films;

FIG. 2A shows the structure of a database of negative film;

FIG. 2B shows the structure of a database of consecutive negative films;

FIG. 3A shows an embodiment of this invention for a negative film;

FIG. 3B shows a database of negative film applied in the embodiment shown in FIG. 3A;

FIG. 4A shows an embodiment of this invention for consecutive negative films; and

FIG. 4B shows a database of consecutive negative films applied in the embodiment shown in FIG. 4A.

### DETAILED DESCRIPTION OF THE INVENTION

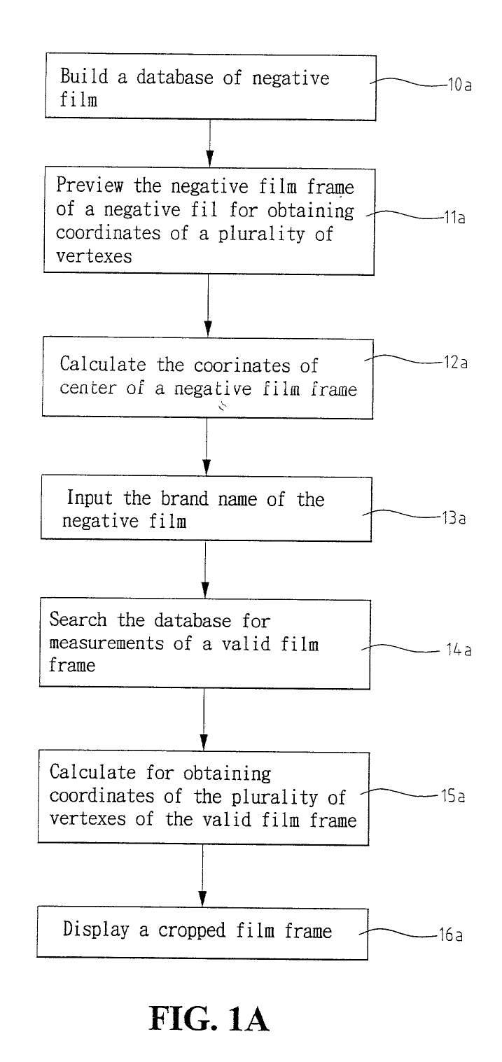

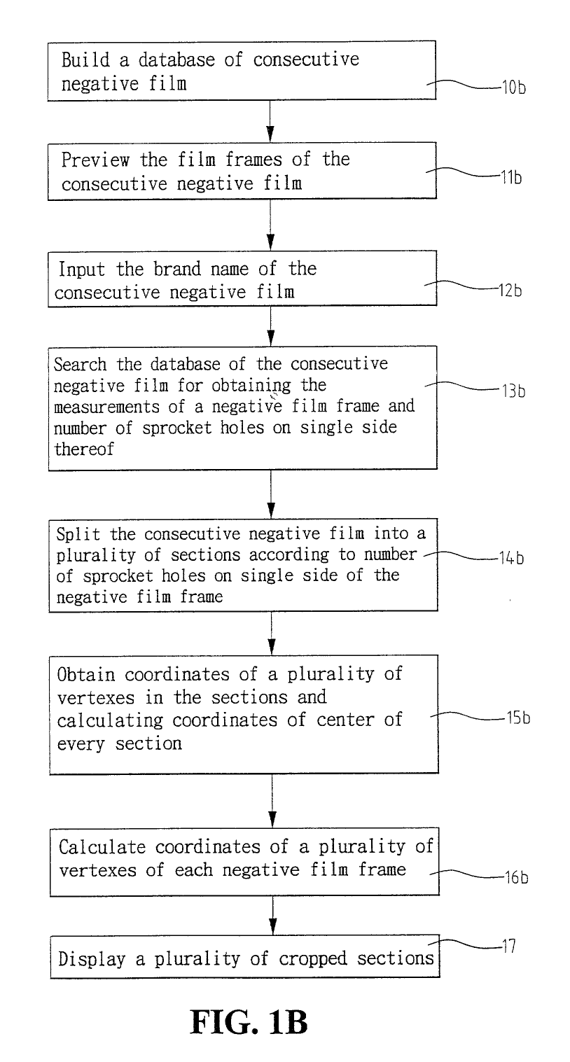

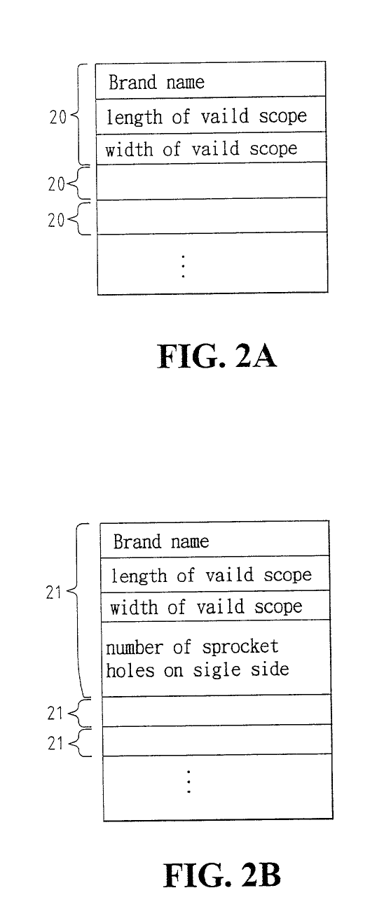

FIG. 1A shows a flowchart in performance of this invention for a negative film. In FIG. 1A, a step 10a is to build a database of negative film stored in a scanner's storage device for application of a scanner driver. The database of negative film shown in FIG. 2A contains a plurality of records 20, in which each record 20 is composed of a brand name and measurements of a valid scope of a negative film. A step 11a is to preview the negative film frame of a negative film for obtaining coordinates of a plurality of vertexes, and a step 12a is to calculate the coordinates of center of the negative film frame according to the coordinates of the plurality of vertexes. A step 13a is to input the brand name of the negative film through an input interface of the scanner driver, and a step 14a is to search the database for measurements of a valid film frame according to the brand name of the negative film. Moreover, a step 15a is to calculate for obtaining coordinates of the plurality of vertexes of the valid film frame according to the coordinates of the center and measurements of the valid scope thereof. Finally, a step 16a is to display a cropped film frame, namely the valid frame scope of the negative film, according to the obtained coordinates of the plurality of coordinates of the valid scope.

FIG. 1B shows a flowchart in performance of this invention for a consecutive negative film. In FIG. 1B, a step 10b is to build a database of consecutive negative film stored in a storage device of scanner for application of a scanner driver. The database of the consecutive negative film shown in FIG. 2B contains a plurality of records 21, in which each record 21 is composed of a brand name, measurements, and number of sprocket holes on single side of a negative film frame of the consecutive negative film. A step 11b is to preview the film frames of the consecutive negative film, and a step 12b is to input the brand name of the consecutive negative film through an input interface of the scanner driver. A step 13b is to search the database of the consecutive negative film for obtaining the measurements of a negative film frame and number of sprocket holes on single side thereof. A step 14b is to split the consecutive negative film into a plurality of sections according to number of sprocket holes on single side of the negative film frame. Moreover, a step 15b is to obtain coordinates of a plurality of vertexes in the sections and calculating coordinates of center of every section, namely coordinates of center of every negative film frame, basing on the coordinates of the vertexes. Finally, a step 16b is to calculate coordinates of a plurality of vertexes of each negative film frame basing on measurements of each negative film frame of a consecutive negative film of certain brand and the coordinates of center of each negative film frame. And, a step 17 is to display a plurality of cropped sections, which represents the valid scope of the consecutive negative film, according to the obtained coordinates of the plurality of vertexes of each negative film frame.

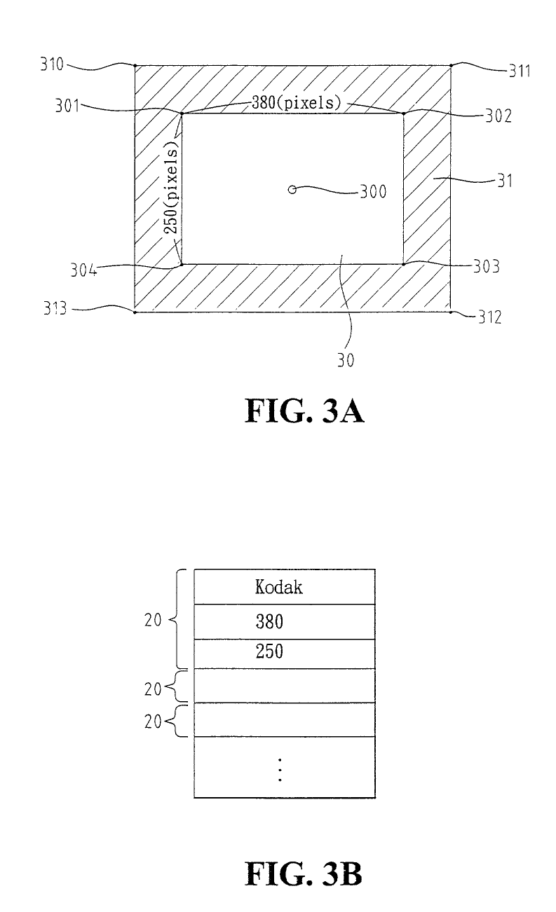

FIG. 3A shows an embodiment of this invention for a negative film, in which the method of this invention excludes an invalid scope 31 and autocrop a scope of valid frame 30. In a conventional method for scanning a negative film, the negative film must be previewed before scanning so as to fetch coordinates of a plurality of vertexes 310, 311, 312, 313 on a scan platform and calculate the coordinates of center 300 of the negative film frame according to the obtained coordinates of the vertexes.

The brand of the negative film shown in FIG. 3A is “Kodak”, whose scope of valid frame 30 including 380 pixels in length and 250 pixels in width can be found in the database of negative film shown in FIG. 3B. The coordinates of a plurality of vertexes 301, 302, 303, 304 in the scope of valid frame 30 can be thus calculated and acquired. Then, basing on the coordinates of the vertexes 301, 302, 303, 304, the scanner is enabled to show a cropped scope, namely the scope of a valid frame 30. Calculation of the coordinates of the foregoing center is reckoned by an operation unit in the scanner according to the geometric coordinate concept.

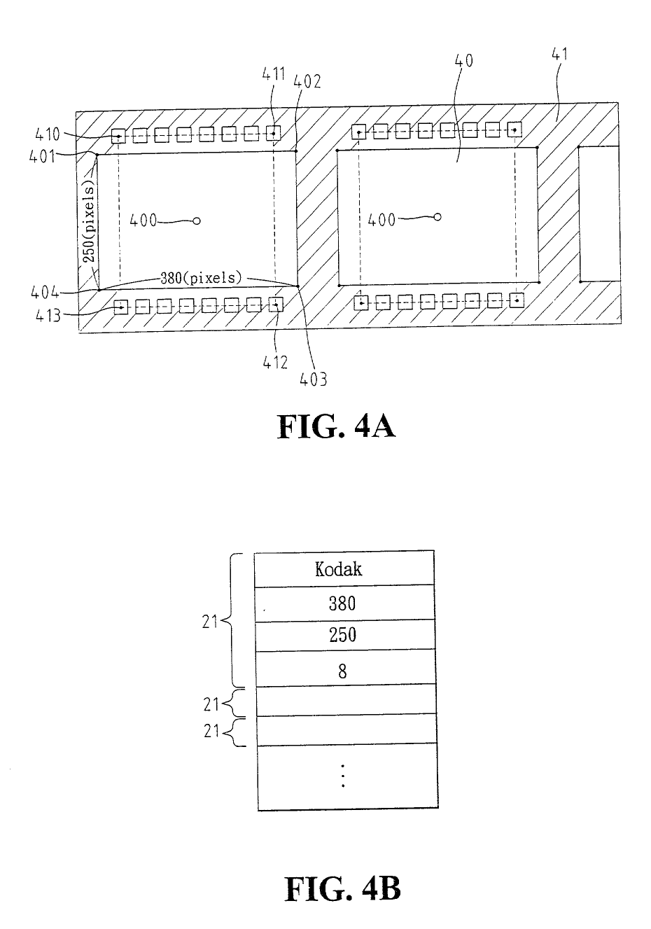

FIG. 4A shows an embodiment of this invention for a consecutive negative film. In FIG. 4A, an invalid portion (hatched portion) 41 is excluded, only a scope of valid frame 40 of the consecutive negative film is autocropped, and as mentioned, preview of the consecutive negative film would be required before scanning.

The brand of the negative film shown in FIG. 4A is “Kodak”, in which the scope of a plurality of valid frames 40 including 380 pixels in length, 250 pixels in width, and 8 sprocket holes on single side can be found in the database of negative film shown in FIG. 4B, and the scope of the plurality of valid frames 40 is the scope of valid frames 40 of the consecutive negative frames 40. Moreover, a plurality of sections is split by dotted lines shown in FIG. 4A by every 8 sprocket holes as a unit on single side of a valid frame so that coordinates of a plurality of vertexes 410, 411, 412, 413 in sections are obtainable. The procedure of this method is supposed to calculate the coordinates of the center 400 of every section, that is the coordinates of the center 400 of each valid frame 40. Then, the procedure goes to calculate the coordinates of the center 400 in every section, namely the coordinates of the center 400 in every negative film frame 40, according to the coordinates of the plurality of vertexes 410, 411, 412, 413. The following step is to calculate the coordinates of a plurality of vertexes 401, 402, 403, 404 of each valid frame 40 according to the coordinates of the center 400 of each valid frame 40 and the measurements thereof, such that the scanner can show a plurality of film frames, that is the valid frames 40 of the consecutive negative film based on the coordinates of the vertexes 401, 402, 403, 404. The foregoing center is reckoned by an operation unit in the scanner according to the geometric coordinate concept.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method for scanning and autocropping the valid scope of a negative film frame, comprising the following steps:
(A) Building a database of negative film for application of a scanner's driver, wherein a brand name of negative film and measurements of the valid scope of a negative film frame are recorded in the database;
(B) Previewing a negative film frame for obtaining coordinates of a plurality of vertexes thereof;
(C) Calculating the coordinates of center of the negative film frame according to the coordinates of the vertexes of the negative film frame;
(D) Inputting the brand name of the negative film through an input interface of the scanner's driver;
(E) Searching the database of negative film for measurements of a valid scope of the negative film frame according to the brand name of the negative film;
(F) Calculating coordinates of the plurality of vertexes in the valid scope of the negative film frame according to the coordinates of center and measurements of the valid scope of the negative film frame; and
(G) Showing a cropped scope, namely the valid scope of the negative film frame, according to coordinates of a plurality of vertexes of the negative film frame.

2. The method according to claim 1, wherein the database of negative film in step (A) is stored in a storage device of the scanner.

3. The method according to claim 1, wherein the scanner is a negative film scanner or a platform scanner.

4. A method for scanning and autocropping the valid scope of frames of a consecutive negative film, comprising the following steps:
(A) Building a database of consecutive negative film for application of a scanner's driver, wherein a brand name of consecutive negative film and measurements of valid scope of frames of the consecutive negative film are recorded in the database;
(B) Previewing frames of the consecutive negative film for obtaining coordinates of a plurality of vertexes thereof;
(C) Inputting the brand name of the consecutive negative film through an input interface of the scanner's driver;
(D) Searching the database of consecutive negative film for measurements and number of sprocket holes of a negative film frame according to the brand name of the consecutive negative film;
(E) Splitting the consecutive negative film into a plurality of sections according to the number of the sprocket holes on single side of the negative film frame;
(F) Trying to obtain coordinates of the plurality of vertexes in the sections of the consecutive negative film and calculating coordinates of the section center of each frame, namely the coordinates of center of the negative film frame, according to the coordinates of the plurality of vertexes of each section; and
(G) Calculating coordinates of a plurality of vertexes in each negative film frame basing on the coordinates of frame center and measurements of every negative film frame; and
(H) Displaying a plurality of cropped frames, namely the valid scope of the consecutive negative film, basing on the coordinates of the plurality of vertexes of each negative film frame.

5. The method according to claim 4, wherein the database of consecutive negative film in step (A) is stored in a storage device of the scanner.

6. The method according to claim 4, wherein the scanner is a negative film scanner or a platform scanner.
